(19) United States
(12) Patent Application Publication
(10) Pub. No.: US 2020/0134742 A1
(43) Pub. Date: Apr. 30, 2020

(54) SYSTEM FOR AUTHORIZING ELECTRIC VEHICLE CHARGING AND PAYMENT THROUGH VEHICLE INFOTAINMENT DEVICE

(71) Applicant: Dexter Turner, Portland, OR (US)

(72) Inventor: Dexter Turner, Portland, OR (US)

(73) Assignee: OpConnect, Inc., Tigard, OR (US)

(21) Appl. No.: 16/172,773

(22) Filed: Oct. 27, 2018

(51) Int. Cl. G06Q 50/06; G06Q 20/40; G06Q 20/32; B60L 53/66; B60L 53/65

(52) U.S. Cl. CPC G06Q 50/06; G06Q 20/40; B60L 53/65; B60L 53/665; G06Q 20/322

(57) ABSTRACT

Disclosed herein are representative embodiments of methods, apparatus, and systems relating to a system to use electric vehicle supply equipment (“EVSE”) and electric vehicles (EV) vehicle infotainment systems (VIS) to authorize or pay for the use of EVSE from the EV VIS.

### CROSS-REFERENCE TO RELATED APPLICATIONS

This application claims the benefit of U.S. Provisional Application No. 62/707,216, filed on Oct. 26, 2017 and entitled “SYSTEM FOR AUTHORIZING ELECTRIC VEHICLE CHARGING AND PAYMENT THROUGH VEHICLE INFOTINMENT DEVICE”; which IS hereby incorporated herein by reference.

### FIELD

This application relates to electric vehicle charging and associated systems.

### SUMMARY

Disclosed below are representative embodiments of methods, apparatus, and systems relating to a system to use electric vehicle charging stations (“EVCSs”), also known as electric vehicle supply equipment (“EVSE”), and an electric vehicle's (EV) infotainment system (“EVIS”) for the payment of both vehicle parking and the charging of electric vehicles. The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. Furthermore, any features or aspects of the disclosed embodiments can be used in various combinations and subcombinations with one another.

Among the embodiments disclosed herein are EV infotainment systems (VIS) and EVSE to control access to and payment for the use of EVSE as well as payment for parking. Embodiments of the disclosed technology can be used to improve the basic process of charging an EV by eliminating the need to interact with the EV charging station to authorize and pay for electricity delivered from the EVSE to the EV and optionally, simultaneously pay for parking the EV. Among the disclosed embodiments is an access control and payment system that uses the EV's infotainment system to pay for a charging session and optionally parking, if it can be included with the vehicle charging.

One exemplary embodiment is a method that comprises an interaction between the EVSE and the EV such that the EV recognizes that it is within proximity of an EVSE and allows the driver to access the EVSE and/or pay for EV charging via interactions with the VIS. Another exemplary embodiment comprises wireless interfaces between the EV, the EV original equipment manufacturer (OEM) and an EV charging service provider (ECSP) such that the EV recognizes that it is within proximity of an EVSE and allows the driver to access the EVSE and/or pay for EV charging via interactions with the VIS. A related embodiment comprises one or more non-transitory computer-readable media storing computer-executable instructions which when executed by a computer cause the computer to perform the method.

Another exemplary embodiment is a computer-implemented method comprising the exchange of data between an EVSE and an VIS, the data identifying an EVSE at the infotainment system and identifying a user to the EVSE, identifying a unique charging session at the EVSE, and also identifying a unique parking session; accessing account data associated with the user and control policies and pricing data associated with the EVSE and/or the parking facility; using a combination of this data to determine if the user is authorized to complete a charging session at the EVSE; and processing payment for both the use of the EVSE and parking at the parking facility in a single transaction. A related embodiment comprises one or more non-transitory computer-readable media storing computer-executable instructions which when executed by a computer cause the computer to perform the method.

Embodiments of the disclosed systems and methods can be implemented using computing hardware, such as a computer processor embedded in the EVSE and a vehicle infotainment system (VIS). Embodiments of the disclosed methods can be performed using software stored on one or more non-transitory computer-readable media (e.g., one or more optical media discs, volatile memory components (such as DRAM or SRAM), or nonvolatile memory or storage components (such as hard drives)). Such software can be executed by a computer processor embedded in the EVSE and VIS or by one or more computers coupled to the EVSE and VIS by a network (e.g., via the Internet, a wide-area network, a local-area network, a client-server network, or other such network). Embodiments of the disclosed methods can also be performed by specialized computing hardware (e.g., one or more application specific integrated circuits (“ASICs”) or programmable logic devices (such as field programmable gate arrays (“FPGAs”)) configured to perform any of the disclosed methods). Additionally, any intermediate or final result created or modified using any of the disclosed methods can be stored on a non-transitory storage medium (e.g., one or more optical media discs, volatile memory or storage components (such as DRAM or SRAM), or nonvolatile memory or storage components (such as hard drives or solid state drives)). Furthermore, any of the software embodiments (comprising, for example, computer-executable instructions which when executed by a computer cause the computer to perform any of the disclosed methods) or results (either intermediate or final) created or modified by the disclosed methods can be transmitted, received, or accessed through a suitable communication means.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic block diagram illustrating an exemplary electric vehicle charging system, an electric vehicle and electric vehicle and electric vehicle charging system back offices connected via a network.

FIG. 2 is a schematic block diagram illustrating an exemplary EVSE system integrated with an electric vehicle and the users of the exemplary system.

FIG. 3 is a flowchart of an exemplary method for using an EV infotainment system to pay for or authorize vehicle charging on an EVSE according to an embodiment of the disclosed technology.

FIG. 4 illustrates an exemplary VIS screen showing a possible user interface informing the user of the EVSE pricing and allowing the user to accept the fees to use the EVSE.

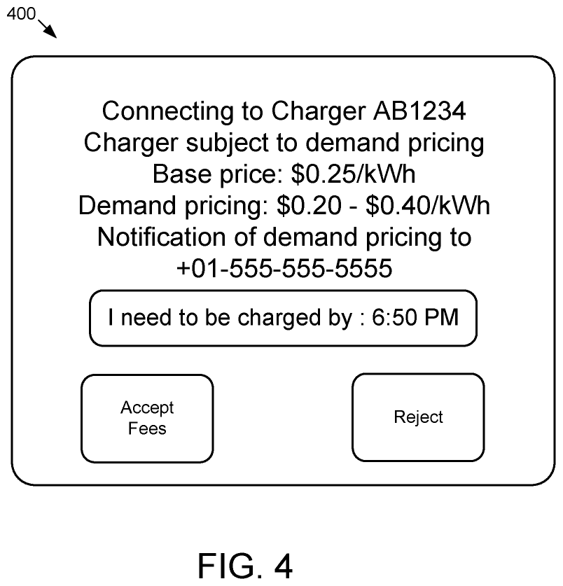

FIG. 5 is a schematic block diagram of an exemplary computing environment for implementing embodiments of the disclosed technology.

### DETAILED DESCRIPTION

### I. General Considerations

Disclosed below are representative embodiments of methods, apparatus, and systems for using and operating electric vehicle charging stations (“EVCSs”) or electric vehicle supply equipment (“EVSE”) that are interfaced with electric vehicle (EV) vehicle infotainment systems (VIS) for the purposes of authorizing or paying for EV charging via the VIS. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used in various combinations and subcombinations with one another. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “monitor” to describe the disclosed methods. These terms are high-level abstractions of the actual operations that are performed. The actual operations that correspond to these terms may vary depending on the particular implementation and are readily discernible by one of ordinary skill in the art. Furthermore, as used herein, the term “and/or” means any one item or combination of items in the phrase.

Any of the disclosed methods can be implemented using computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives)) and executed on a computer (e.g., any commercially available computer or a computer processor embedded in the EVSE and VIS). Any of the intermediate or final data created and used during implementation of the disclosed methods or systems can also be stored on one or more computer-readable media (e.g., non-transitory computer-readable media).

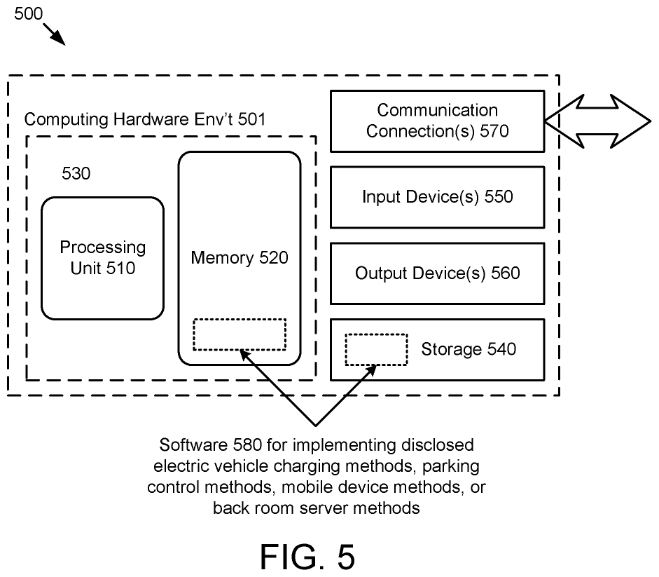

FIG. 5 is a schematic block diagram 500 that illustrates a generalized example of a suitable computing hardware environment 501 in which embodiments of the disclosed technology can be implemented. The computing hardware environment 501 is not intended to suggest any limitation as to the scope of use or functionality of the disclosed technology, as the technology can be implemented in diverse general-purpose or special-purpose computing environments.

With reference to FIG. 5, the computing hardware environment 501 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM, DRAM, SRAM), non-volatile memory (e.g., ROM, EEPROM, flash memory), or some combination of the two. The memory 520 can store software 580 for implementing one or more of the described techniques for operating or using the disclosed electric vehicle charging systems. For example, the memory 520 can store software 580 for implementing any of the disclosed methods and their accompanying user interfaces.

The computing hardware environment can have additional features. For example, the computing hardware environment 501 includes storage 540, one or more input devices 550, one or more output devices 560, and one or more communication connections 570. An interconnection mechanism (not shown) such as a bus, controller, or network interconnects the components of the computing hardware environment 501. Typically, operating system software (not shown) provides an operating environment for other software executing in the computing hardware environment 501, and coordinates activities of the components of the computing hardware environment 501.

Storage 540 is a type non-volatile memory and can be removable or non-removable. The storage 540 includes, for instance, magnetic disks (e.g., hard drives), magnetic tapes or cassettes, optical storage media (e.g., CD-ROMs or DVDs), or any other tangible non-transitory storage medium which can be used to store information and which can be accessed within or by the computing hardware environment 501. The storage 540 can store the software 580 for implementing any of the described techniques, systems, or environments.

The input device(s) 550 can be a touch input device such as a keyboard, mouse, touch screen, pen, trackball, a voice input device, a scanning device, or another device that provides input to the computing environment 501. The output device(s) 560 can be a display, touch screen, printer, speaker, or another device that provides output from the computing environment 501.

The communication connection(s) 570 enable communication over a communication medium to another computing entity. The communication medium conveys information such as computer-executable instructions, any of the intermediate or final messages or data used in implementing embodiments of the disclosed technology, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier. For example, the communication connection(s) 570 can communicate with another computing entity over a wired or wireless network (e.g., the Internet, a wide-area network, a local-area network, a Wi-Fi network, a client-server network, a wireless mesh network, or other such network or any combination thereof).

Many of the methods, systems, and interfaces disclosed herein can be described in the general context of computer-executable instructions stored on one or more computer-readable media. Computer-readable media are any available media that can be accessed within or by a computing environment. By way of example, and not limitation, with the computing hardware environment 501, computer-readable media include tangible non-transitory computer-readable media such as memory 520 and storage 540 and do not encompass transitory carrier waves or signals. The various methods, systems, and interfaces disclosed herein can also be described in the general context of computer-executable instructions, such as those included in program modules, being executed in a computing environment on a target real or virtual processor. Generally, program modules include routines, programs, libraries, objects, classes, components, data structures, and the like that perform particular tasks or implement particular abstract data types. The functionality of the program modules may be combined or split between program modules as desired in various embodiments. Computer-executable instructions for program modules may be executed within a local or distributed computing environment.

### II. Exemplary Embodiments of the Disclosed Technology

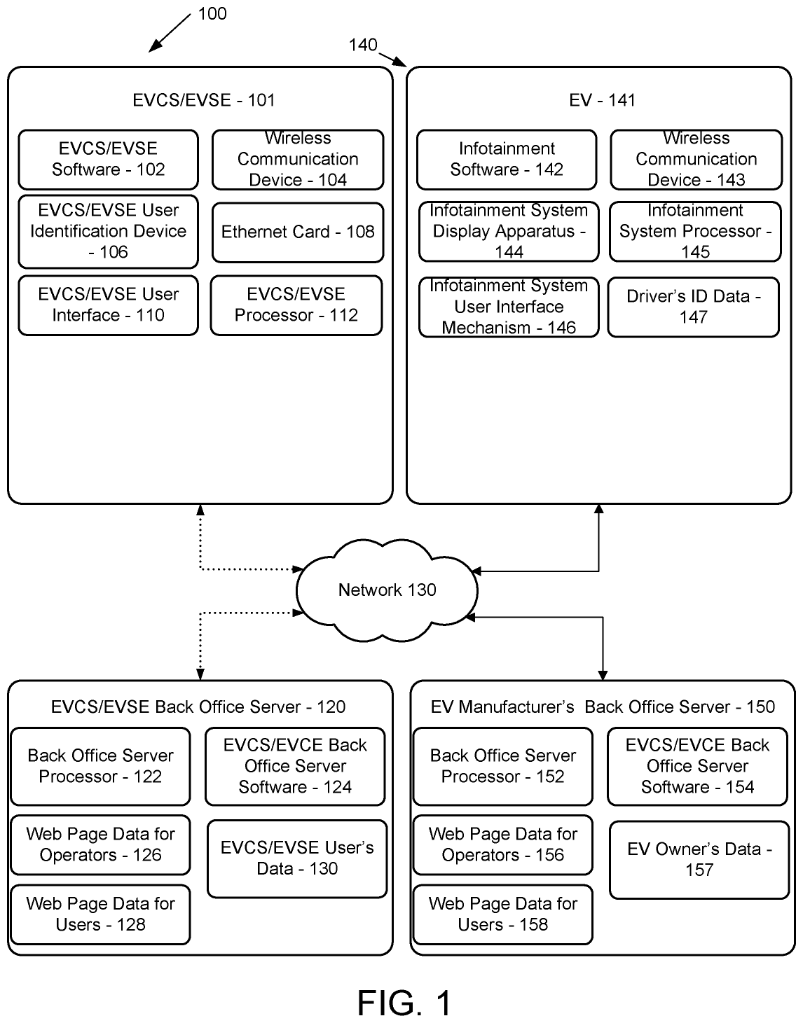

FIG. 1 is a schematic block diagram 100 illustrating an EVSE computing hardware environment 101 for implementing embodiments of the disclosed technology. In particular, FIG. 1 illustrates an exemplary computing hardware environment 101 for an EVSE and an exemplary computing hardware environment 120 for an EVSE back office server. The EVSE environment 101 is more specialized than computing hardware environment 501 but should not be construed as limiting the types of hardware that can be used to implement the disclosed technology. Furthermore, the EVSE environment 101 and the exemplary computing hardware environment 120 for the EVSE back office server can include any of the components described above with respect to the general computing hardware environment 501.

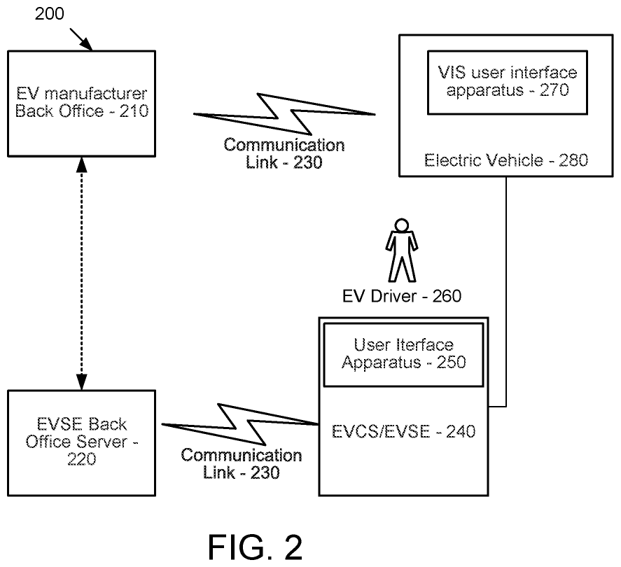

The EVSE computing hardware environment 101 includes software 102, which comprises computer-executable instructions stored on non-transitory computer-readable media (e.g., any one or more of the non-transitory computer-readable media described above). When executed, the software can be used to implement the functionality of the EVSE, which is described in more detail below. The EVSE computing hardware environment 101 further comprises an EVSE processor 112 for executing the software 102. Suitable processors and associated parts can be obtained, for example, from Parvus Corporation. In certain exemplary embodiments, the EVSE software 102 is used to implement a process in which commands and data are exchanged to control the access to the EVSE or payment for use of the EVCS/ESE to charge electric vehicles plugged into the EVSE (e.g., the EVSE 240 shown in FIG. 2). The EVSE computing hardware environment 101 can also include one or more wireless communication devices 104 (such as a cellular radio or Wi-Fi radio), and/or an Ethernet card 108 (or other network adapter) to provide the environment 101 with a wired and wireless interface capabilities for exchanging data with, for example, an EVSE back office server 120. Suitable wireless radios and associated parts can be obtained, for example, from Digi International. The EVSE computing hardware environment 101 also includes a user identification device 106, such as an RFID tag reader or magnetic strip card reader, and a user interface 110, such as an LCD or LED. The user interface can be a touch or non-touch screen display, buttons, keypads or lights with placarded instructions. Suitable identification devices and associated parts can be obtained, for example, from ID Tech. Suitable user interfaces can be obtained, for example, from Logic Supply.

As more fully described below, the user interface 110 can be used to facilitate the charging of the electric vehicle and the proper billing (or crediting) for the electricity used by (or supplied to) the electric vehicle coupled to the EVSE. As shown in FIG. 1, the EVSE computing hardware environment 101 is coupled to the EVSE back office server environment 120 via the network 130 (e.g., the Internet, a wide-area network, a local-area network, a Wi-Fi network, a client-server network, a wireless mesh network, or other such network or any combination thereof). In particular embodiments, the back office server environment 120 is implemented as part of a cloud-based back office server.

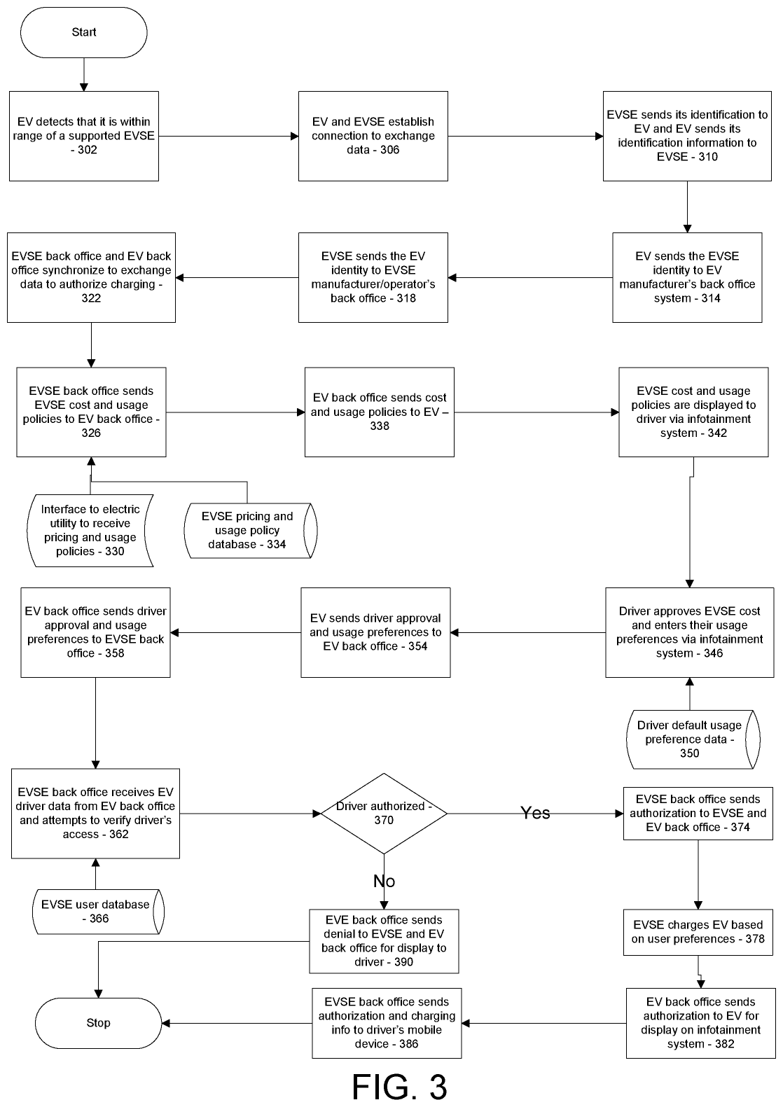

In operation, the EVSE computing hardware environment 100 can create a number of data packets or messages that are transmitted to the EVSE back office server environment 102 via a network 130. The EVSE back office server environment 102 can receive these packets or messages and can also create data packets or messages that will be transmitted to the EVSE computing hardware environment 100 via the network 130. An exemplary method and system for communicating between the EVSE computing hardware environment 100 and the back-office server environment 120 is described below in connection with FIG. 3.

Returning to FIG. 1, the back office server environment 120 can be implemented using a wide variety of computers and/or servers (e.g., a suitable commercially available server). In FIG. 1, the back office server environment 120 includes back office server software 124, which can comprise computer-executable instructions stored on non-transitory computer-readable media (e.g., any one or more of the non-transitory computer-readable media described above). When executed, the software can be used to implement the functionality of the back office server, which is described in more detail below. The EVSE back office server 120 further comprises a back-office server processor 122 for executing software 124. Also shown in FIG. 1 is EVSC/EVSE user data 130. The EVSC/EVSE user data 130 can comprise data stored on non-transitory computer-readable media that is related to users of the EVSE. For example, the data can include data about a user's identification, address, account credit balance, usage history, vehicle, and/or other such user data.

In the illustrated embodiment, the EVSE back office server 120 also includes data 126 for implementing one or more web pages for an EVSE operator. The web page data 126 can comprise data stored on non-transitory computer-readable media that is used to render or otherwise implement one or more web pages for display to an EVSE operator. The web pages can be displayed, for example, using a suitable Internet browser or media player implemented at a computer operated by the EVSE operator and coupled to the back-office server 120 via a network (e.g., the Internet, a wide-area network, a local-area network, a Wi-Fi network, a client-server network, a wireless mesh network, or other such network or any combination thereof). The web page data can be in any format or language suitable for implementing web pages (e.g., HTML, Flash, Java, and the like). In other embodiments, the data to be displayed to the EVSE operator is not stored as web page data, but as data usable via a non-web-based user interface (e.g., a dedicated program that directly interfaces with the back-office server 120).

The EVSE back office server 120 can also include data 128 for implementing one or more web pages for an EVSE user. The web page data 128 can comprise data stored on non-transitory computer-readable media that is used to render or otherwise implement one or more web pages for display to an EVSE user. The web pages can be displayed, for example, using a suitable Internet browser or media player implemented at a computer operated by the EVSE user and coupled to the back-office server 120 via a network (e.g., the Internet, a wide-area network, a local-area network, a Wi-Fi network, a client-server network, a wireless mesh network, or other such network or any combination thereof). The web page data can be in any format or language suitable for implementing web pages (e.g., HTML, Flash, Java, and the like). In other embodiments, the data to be displayed to the EVSE user is not stored as web page data, but as data usable via a non-web-based user interface (e.g., a dedicated program that directly interfaces with the back-office server 120). In certain embodiments, the web page data 128 is data for implementing web pages that show the user information about the state of the user's account, including amount of credit balance and purchase history. For example, the web page data can include data for implementing a log-in screen, through which the user can provide authentication information indicating that the user is a member of a group authorized to use an EVSE in a network of EVCSs/EVSE controlled by the back EVSE back office server 120, and a data for implementing an account status screen, through which the user is presented a graphical or numerical indication of the state of the user's account. The EVCS/EVCE back office server software 124 can include code that receives information about the identity of the user at the log-in screen, matches the identity to an EVCS user database and causes the display of the information about the state of the user's account via one or more web pages displayed to the user. The information about the user's account can comprise, for instance, the current credit balance in the account, the method of payment (e.g., credit/debit card or bank account information) to be used for electric charging payment purposes, and a record of past charges against this account.

In the illustrated embodiment, the EV 141 includes a VIS that can include a number of components such as infotainment software 142, an infotainment system display apparatus 144, an infotainment system user interface mechanism 146, a wireless communication device 143, an infotainment system processor 146 and a mechanism to store the driver's identification data 147.

In operation, the EV infotainment system computing hardware environment 140 can create a number of data packets or messages that are transmitted to the EV manufacturer's back office server environment 150 via a network 130. The EV back office server environment 150 can receive these packets or messages and can also create data packets or messages that will be transmitted to the EV computing hardware environment 140 via the network 130. An exemplary method and system for communicating between the EV computing hardware environment 140 and the back office server environment 150 is described below in connection with FIG. 3.

FIG. 2 is a schematic block diagram 200 illustrating an exemplary EVSE and EV system and the users of the exemplary system. In FIG. 2, a user 260 interfaces with an EVSE 240 using a user interface apparatus 250 (e.g., a display apparatus) and the VIS interface apparatus 270. The apparatus 270 allows the user to view information about the EVSE 240 and make selections about their charging preferences. As noted above, the functionality of the apparatus 270 can be implemented by executing appropriate EV VIS software stored at the EV VIS (e.g., infotainment software 142).

The EVSE back office server 220 in FIG. 2 is also configured to operate a website 128 for exchanging information relative to the EVSE/EVSE with the EVSE user 260. The information can comprise, for example, the current status of the user's account, account records for the user, or other such information. The user 260 can use this website to increase the credit balance on their account and manage payment sources (i.e. link the account to a bank account or credit/debit card).

In the illustrated embodiment, when an EV 280 recognizes that it is within the vicinity of an EVSE 240 the EV and EVSE can establish a wireless connection for the exchange of data packets. Further, the EVSE and EV can communicate with their respective back office services via communications links for the purposes of identifying the owner of the EV 260 to the EVSE back office server 220 and the acceptance or rejection of the EV driver 260 for electric charging services for their EV. Furthermore, although the EV manufacturer's back office 210 and the VCS/EVSE back office server 220 are shown as distinct in FIG. 2, it is to be understood that in some embodiments the functions of the two servers may be performed by a single computer or server and operated by a single entity.

FIG. 3 is a flow chart 300 showing an exemplary process for using an EV VIS to pay for electricity usage, and potentially parking, and to have the control of the charging session managed by a supporting electric utility using the disclosed technology. As noted above, the functionality shown in FIG. 3 can be implemented by computing hardware executing computer-executable instructions. The various procedures shown in FIG. 3 should not be construed as limiting, as any one or more of the procedures can be performed alone or in various other combinations and subcombinations with one another.

In particular embodiments, the EV will detect that it is within the vicinity of an EVSE by using its GPS location and a stored database or EVSE or wireless communication between the EV and EVSE (process block 302). The EV and EVSE can establish a (wireless) connection for the exchange of data to facilitate the authorization of electric charging of the EV (process block 306). The EVSE can send its unique identifier to the EV and the EV can also send its unique identifier (VIN) to the EVSE so that each will know what its connected to (process bock 310). The EV then sends the EVSE identifier and it's identifier to the EV manufacturer's back office system (process block 314). The EVSE will also send the EV's identifier and it's identifier to the EVSE manufacturer's or operator's back office (process block 318). The EVSE back office may retrieve pricing and usage policy information about the EVSE from either its own database (process block 334) or it may interface with an electric utility that serves or owns the EVSE to receive these data (process block 330) and send them to the EV back office (process block 326). The EV back office will send the cost and usage policy policies to the EV for display to the driver on the VIS (process block 338 and 342). Usage policies may include hours of operation or whether the standard pricing to use the EVSE can be overridden by demand or surge pricing dictated by either the EVSE owner/operator or the electric utility serving or owning the EVSE.

After viewing the pricing and usage policies for the EVSE, the driver can enter their usage preferences and approve (or reject) the pricing and usage policies via the VIS (process block 346). The EV and VIS may have default user preferences that are stored in a database in the VIS and used to populate their choices in the VIS (process block 350). After the user makes their selections, the EV sends the driver data, approval of the prices and usage policies and the driver's preferences to the EV back office (process block 354). After receiving this information, the EV back office sends the approval and usage preferences to the EVSE back office (process block 358). Once the EVSE back office receives these data from the EV back office, it will use the EVSE user database of registered accounts (process block 366) to attempt to verify whether the driver is authorized to charge at this EVSE (process block 362). If the EVSE back office determines that the driver is authorized (process block 370) it will send the authorization (request to start charging) to the EVSE and the EV back office (process block 374). Once the EVSE receives the authorization, it will charge the EV based on the user preferences and the policies of the EVSE. An example of these policies and preferences are the time that the driver wishes to have their EV charged by and any demand response activities of the EVSE owner/operator or electric utility serving or owning the EVSE to curtain charging during peak demand periods.

Once the EV back office receives the authorization from the EVSE back office it will send this authorization to the EV VIS for display to the driver (process block 382). The EVSE back office can also send the authorization and any notes on pricing and policies to the driver's mobile device (process block 386).

### III. Further Embodiments

Having described and illustrated the principles of the disclosed technology in the detailed description and accompanying drawings, it will be recognized that the various embodiments can be modified in arrangement and detail without departing from such principles. Furthermore, any features or aspects of the disclosed embodiments can be used in various combinations and subcombinations with one another.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims and their equivalents. I therefore claim as my invention all that comes within the scope and spirit of these claims and their equivalents.

What is claimed is:

1. A method of authorizing or paying for electric vehicle (EV) charging from an EV vehicle infotainment system (VIS), comprising:
by computing hardware,
obtaining an EV and EV driver's unique identifier from the VIS; and
combining the EV and EV driver's identifier to form a dataset that can be used to process access or payment for both the charging session; and
transmitting the dataset to a back-end EV manufacturer server; and
obtaining a unique EVSE identifier and charging session identifier from the EVSE; and
transmitting the dataset to a back-end EVSE/EVCS server; and
exchanging datasets between the back-end EV manufacturer server and back-end EVSE/EVCS server to authorize the EV driver's use of the EVSE.

2. The method of claim 1, further comprising:
Allowing the EV driver to establish default preferences for their charging session, such as the maximum price that they are willing to pay for energy, the latest time at which they which their EV to be fully charged, and the minimum price that they will sell energy from the EV's battery back to the grid via the EV VIS with said preferences to be stored in a readable database in the EV VIS.

3. The method of claims 1 and 2, further comprising:
Allowing the EV driver to override their default preferences at the time that they wish to authorize or pay for a charging session via the EV VIS.

4. The method of claims 1, 2 and 3, further comprising:
Including the EV driver's preferences in data packets that are sent to the back-end EVSE/EVSE server from the EV VIS for control of the EV charging session.

5. The method of claim 1, further comprising:
Combining the payment for both the charging session and parking at the parking facility into a single authorization once the dataset comprising the EV driver's unique identifier and EVSE identifiers are received at the back-end EVSE/EVSE server

6. The method of claim 1, further comprising:
Processing the authorization or payment for the charging session; and
transmitting a message to the EV driver's mobile device indicating that their charging has been authorized and the pricing and usage policies that are applicable to the EVSE that the EV driver wishes to use.

7. The method of claim 1, further comprising:
Processing the authorization or payment for the charging session once the total cost of the charging session is known; and
transmitting the results of the payment processing to the EV VIS for display to the EV driver.

8. The method of claim 1, further comprising:
Processing the authorization or payment for the charging session once the total cost of the charging session is known; and
transmitting the results of the payment processing to the EV driver's mobile device for display to the EV driver.

9. The method of claim 1, wherein the method further comprises the EVSE receiving a response from the back-end EVSE server indicating whether the user is authorized to use the EVCS or EVSE.

10. The method of claim 1, wherein the method further comprises the back-end EV server receiving a response from the back-end EVSE server indicating whether the user is authorized to use the EVCS or EVSE and transmitting their response to the EV VIS for display to the EV driver.

11. One or more non-transitory computer-readable media storing computer-executable instructions which when executed by a processor cause the processor to perform a method of allowing an EV driver to access or pay for a charging session at an electric vehicle charging station (“EVCS”) or electric vehicle supply equipment (“EVSE”), including payment for a parking session, the method comprising:
obtaining an EV and EV driver's unique identifier from the VIS; and
combining the EV and EV driver's identifier to form a dataset that can be used to process access or payment for both the charging session; and
transmitting the dataset to a back-end EV manufacturer server; and
obtaining a unique EVSE identifier and charging session identifier from the EVSE; and
transmitting the dataset to a back-end EVSE/EVCS server; and
exchanging datasets between the back-end EV manufacturer server and back-end EVSE/EVCS server to authorize the EV driver's use of the EVSE.

12. The one or more non-transitory computer-readable media of claim 9, wherein the access or payment of the use of the EVSE/EVCS is performed by a software application running on the EVSE and EV VIS.

13. The one or more non-transitory computer-readable media of claim 9, wherein the method further comprises receiving a message from a back-end server indicating that the user has properly accessed or paid to use the EVSE/EVCS and for parking at the parking facility.
